(19) United States
(12) Patent Application Publication
(10) Pub. No.: US 2016/0307093 A1
(43) Pub. Date: Oct. 20, 2016

(54) Button with a near field communication module

(71) Applicant: Great Giant Fibre Garment Co., Ltd., Taipei City (TW)

(72) Inventor: Kung-Jen HSU, Taipei City (TW)

(21) Appl. No.: 14/792,689

(22) Filed: Jul. 7, 2015

Related U.S. Application Data
(63) Continuation-in-part of application No. 14/713,319, filed on May 15, 2015.

(30) Foreign Application Priority Data
Apr. 14, 2015 (TW) 104205569

(51) Int. Cl. G06K 19/077; A44B 1/08; A44B 1/20

(52) U.S. Cl. CPC G06K 19/07762; A44B 1/20; A44B 1/08

(57) ABSTRACT

A button with a near field communication module comprises a top housing and a bottom base, and the two elements are mounted with four through holes for knit with a needle and a thread. The top housing further comprises a positioning tenon. The bottom base comprises a connecting slot in a location thereof corresponding to the positioning tenon. Furthermore, the bottom base comprises a holding recess in an inner ring thereof to accommodate a near field communication antenna and a near field communication chip. In such a way, anything with the button and a smart device can transmit data reciprocally.

### CROSS REFERENCES TO RELATED APPLICATIONS

This application is a continuation-in-part (CIP) application of U.S. patent application Ser. No. 14/713,319, filed on May 15, 2015, which claims the priority benefit of Taiwan patent application 104205569, filed Apr. 14, 2015, the entire content of which is incorporated herein by reference.

### FIELD OF THE INVENTION

The present invention relates to communications. More specifically, the present invention relates to a button with a near field communication module.

### BACKGROUND OF THE INVENTION

Near field communication (NFC) is a short-range and high-frequency wireless communication technology, and allows electronic devices for contactless and point-to-point data transmission. In our daily life, there are a lot of patented products using near field communication technology. For example, Taiwan patent M496812 discloses an access control system having a near field communication unit and a fingerprint identification unit, and also discloses a management system for wireless connection with the access control system. The access control system can induct a user's fingerprint. In such a way, the management system can identify the user with the access control system for access management and records.

For further example, Taiwan patent M494970 recites a smart timing device. In the smart timing device, a near field communication module of a smart apparatus is connected with another near field communication module of a timing apparatus so that the smart apparatus controls and monitors the timing apparatus.

For yet further example, Taiwan patent M493827 describes a ring comprising a near field communication chip, wherein the near field communication chip is connected with an antenna in a spirally-wound manner. When a finger is slid into the ring, the communicable range of near field communication can be minimized to prevent a reprobate from stealing any data using a near field communication reader.

For yet further example, Taiwan patent M483614 discloses a wireless communication searching device, and the device comprises a portable device with a near field communication warning module embedded therein. The warning module has a first sensor, a display, and a transmitter. The first sensor can induct a sensing element having a second sensor and a speaker both embedded therein. When the first sensor inducts the second sensor, or the second sensor is moved out of the induction scope of the first sensor, the speaker will sound for search or emergency.

For yet further example, China patent 201420401083.0 vested in Beijing Xiaomi Technology Co., Ltd provides a wearable device (also called as “Mi bracelet”). The wearable device is very popular since it's with us, and comprises a top housing, a bottom housing, and an electronic component. The two housings are connected with each other to form a waterproof chamber. The electronic component is mounted in the waterproof chamber, and has a printed circuit board (PCB) and a battery. On the printed circuit board are a wireless communicational receiver and sender and at least one transducer. The wearable device can overcome the malfunction problem in any prior wearable device resulted from the deposition of an USB interface. Therefore, the user can unaffectedly wear or operate the wearable device in a humid environment or underwater.

The applicant, a clothing professional manufacturer, considers that combination of the well-developed near field communication technology and a button commonly used in clothing not only can raise the clothing's added value, but also give the product life. For instance, someone buys a coat having a button mounted with a near field communication module as his mother's birthday gift. After which, an audio/video with his best wishes is recorded in his own mobile phone, and the audio/video is saved in the near field communication module by swiping the mobile phone. When mother receives the gift, the audio/video will be transmitted from the button to her mobile phone by swiping the foregoing mobile phone, and the same file will be shown in her mobile phone. Someone expects that mother will be very happy after watching the audio/video with his best wishes. The filial piety makes the coat a priceless treasure for mother. As such, their family love largely goes beyond the coat's purchase price.

A dealer can use a button with a near field communication device to set up a database for giving customers discount in sales promotion or recording their cumulative consumption points. This business model will provide the button with an immeasurable space to develop.

Although the applicant considers the foregoing idea is very constructive, the applicant senses that the cost reduction for manufacturing the product can enhance its quantity and popularity. Therefore, how to give consideration to the function and the price is critical for the idea to be commercialized.

### SUMMARY OF THE INVENTION

The present invention is provided to overcome the problems in the present technology. That is, the present invention provides a button with a near field communication module. The button comprises a top housing and a bottom base, and the two elements are mounted with four through holes for knit with a needle and a thread. The top housing further comprises a positioning tenon. The bottom base comprises a connecting slot in a location thereof corresponding to the positioning tenon. Furthermore, the bottom base comprises a holding recess in an inner ring thereof to accommodate a near field communication antenna and a near field communication chip.

As the button with a near field communication module is seamed onto a coat, its near field communication module and a smart device, e.g. a mobile phone, can transmit data reciprocally.

### BRIEF DESCRIPTION OF THE DRAWINGS

FIG. 1 is an explosive view of the present invention before being mounted with a near field communication module;

FIG. 2 is an explosive view of the present invention after being mounted with a near field communication module;

FIG. 3 is a schematic view illustrating an implementation of the present invention.

### DETAILED DESCRIPTION OF THE INVENTION

The following preferred embodiments are provided to describe the details and characteristics of the invention, but these embodiments is only for illustration purpose, not for limiting the construction on the invention. The applicant notes that the application of near field communication has been well established in the related industry without any insolvable problems. Obviously, the application encompasses data transmission between a near field communication module and a near field communication device of an electronic device. Therefore, there is no need to give unnecessary details on the application, and the applicant merely emphasizes how the application is used in a button necessary in clothing industry so as to connect the conventional industry and the modern technology.

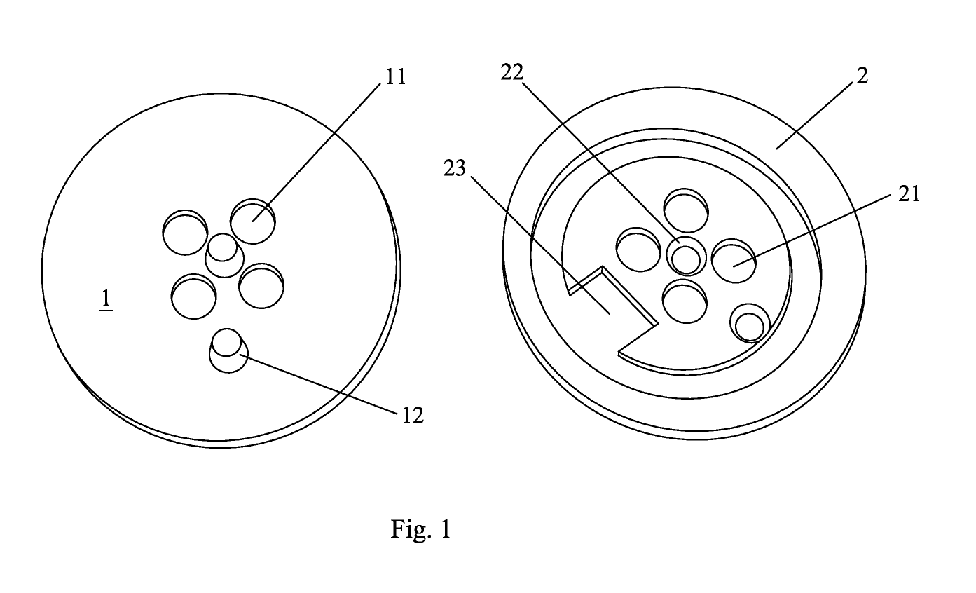

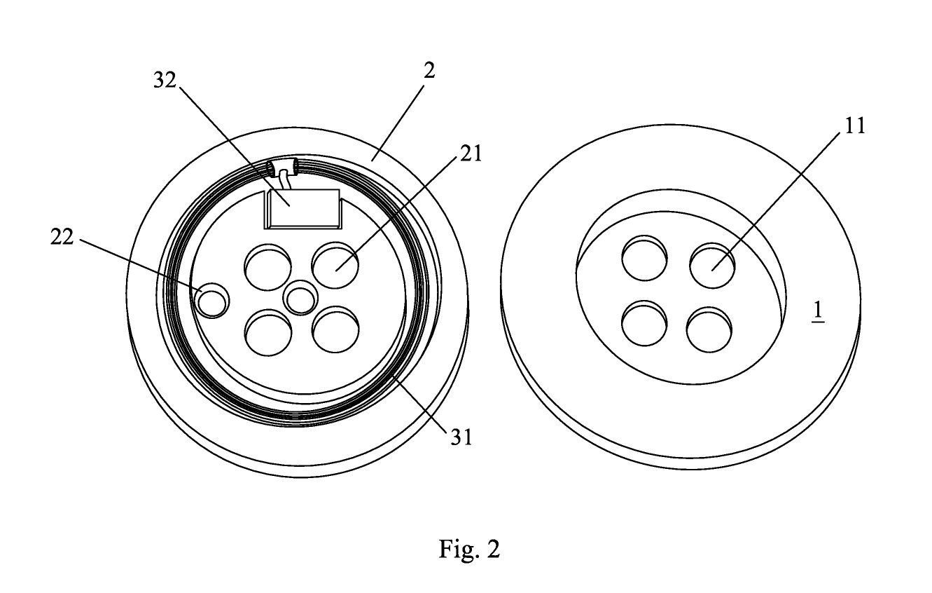

As shown in FIGS. 1-2, a button with a near field communication module of the present invention includes a top housing (1) and a bottom base (2). The both elements have four through holes (11, 21) for knit with a needle and a thread. The top housing (1) further has a positioning tenon (12), and the bottom base (2) has a connecting slot (22) in a location thereof corresponding to the positioning tenon (12). Additionally, the bottom base (2) has a holding recess (23) in an inner ring thereof to accommodate a near field communication antenna (31) and a near field communication chip (32).

As shown in FIG. 2, the near field communication antenna (31) and the near field communication chip (32) are positioned in the holding recess (23) of the bottom base (2). Afterward, the top housing (1) is connected to the bottom base (2) by the insertion of the positioning tenon (12) into the connecting slot (22). Finally, the top housing (1) is securely connected to the bottom base (2) with a high frequency wave or an adhesive. In such way, a waterproof button is formed.

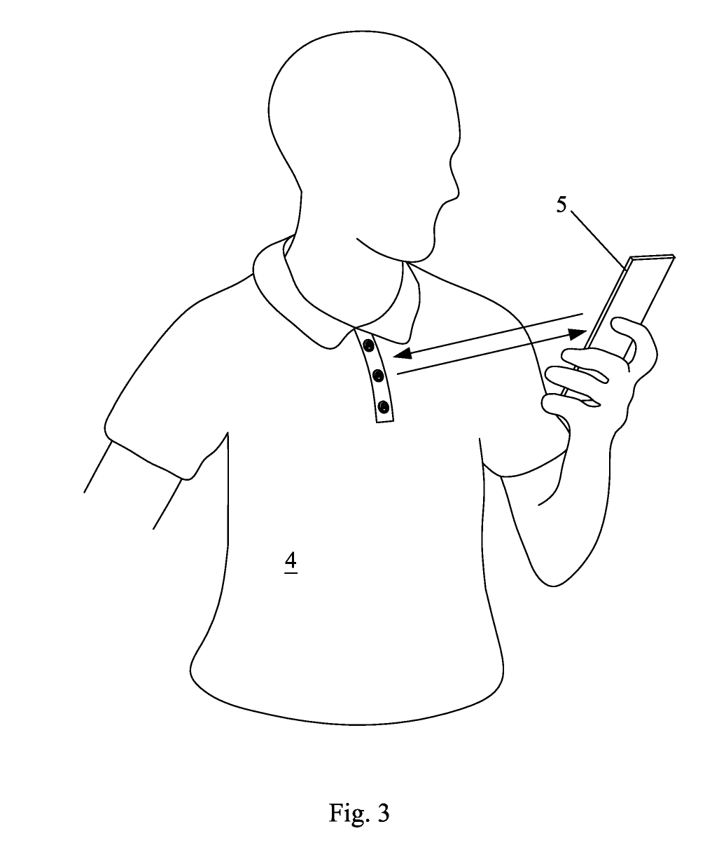

As shown in FIG. 3, after the button is seamed onto a coat (4), the near field communication module in the button and a smart device (5), for example a mobile phone, can transmit data reciprocally at any time. Consequently, the value of the coat (4) is not restricted to the purchase price. Moreover, the coat (4) can be a data transmitter with communication function, and the auxiliary benefits brought by the coat (4) will be unexpected.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A button with a near field communication module, comprising a housing (1) and a base (2); wherein the housing (1) has a positioning element, and the base (2) has a connecting element in a location thereof corresponding to the positioning element and a holding recess (23) to accommodate the near field communication module; the base have a plurality of through holes for knit with a needle and a thread.

2. The button with a near field communication module as claimed in claim 1, wherein the positioning element is a positioning tenon (12).

3. The button with a near field communication module as claimed in claim 1, wherein the connecting element is a connecting slot (22).

4. The button with a near field communication module as claimed in claim 1, wherein the housing is securely connected to the base with a high frequency wave.

5. The button with a near field communication module as claimed in claim 1, wherein the housing is securely connected to the base with an adhesive.

6. (canceled)
